(19) United States
(12) Patent Application Publication
(10) Pub. No.: US 2026/0057217 A1
(43) Pub. Date: Feb. 26, 2026

(54) SYSTEM AND METHOD FOR ENHANCED CONTENT EVALUATION THROUGH DOMAIN-SPECIFIC EMBEDDINGS AND ADAPTIVE COMPARISON TECHNIQUES

(71) Applicant: INTUIT INC., Mountain View, CA (US)

(72) Inventors: Siddharth JAIN, Mountain View, CA (US); Jonathan LIN, Toronto (CA); Sivashanker THIRUCHITTAMPALAM, Toronto (CA); Venkat Narayan VEDAM, Mountain View, CA (US)

(73) Assignee: INTUIT INC., Mountain View, CA (US)

(21) Appl. No.: 18/813,089

(22) Filed: Aug. 23, 2024

(51) Int. Cl. G06N 3/0475

(52) U.S. Cl. CPC G06N 3/0475

(57) ABSTRACT

A system and method are provided to perform enhanced content evaluation.

### BACKGROUND OF THE DISCLOSURE

Many content evaluation methods often fall short when faced with the task of accurately assessing content across diverse domains. These methods typically employ a generalized approach that fails to capture the nuanced requirements and specificities of different content types, leading to evaluations that are neither precise nor fully relevant to the domain in question, which is undesirable. Such discrepancies reveal a significant need for a methodological shift towards evaluation techniques that are capable of recognizing and addressing the unique characteristics of each domain without relying on the generalized capabilities of Large Language Models (LLMs).

### BRIEF DESCRIPTION OF THE FIGURES

FIG. 1 is a block diagram of an example system for enhanced content evaluation according to example embodiments of the present disclosure.

FIG. 2 is a flowchart of an example enhanced content evaluation process according to example embodiments of the present disclosure.

FIG. 3 is an example architecture for enhanced content evaluation according to some embodiments of the present disclosure.

FIG. 4 is server device that can be used within the system of FIG. 1 according to an embodiment of the present disclosure.

FIG. 5 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure relate to a system and method for enhanced content evaluation through domain-specific embeddings and adaptive comparison techniques. The disclosed system and method can generate specialized vector embeddings (i.e., text and other data converted to vectors) via specific refinement and fine-tuning techniques. Such refinement and fine-tuning can tailor the embeddings to distinct content domains, such query generation, response generation, and various others. Moreover, the disclosed system and method can utilize adaptive dimensionality reduction and comparison techniques to enhance evaluation precision by accurately reflecting the unique characteristics and requirements of different domains. The method can include creating the domain-specific embeddings, optimizing the embeddings trough advanced reduction techniques for efficient comparisons, and conducting relevant content assessments. The disclosed embodiments, by strategically refining domain-specific embeddings, customizing dimensionality reduction, and integrating multi-dimensional metrics and biases offers a scalable and nuanced solution for content evaluation. Improved content evaluation can ultimately allow for improving the quality and relevance of content generation across various application areas.

The disclosed system and method can comprise creating and refining domain-specific embeddings using, for example, graph neural networks (GNNs). To further enhance the embeddings' accuracy, domain-specific knowledge can be incorporated via fine-tuning. Such embeddings can be converted into high-dimensional vectors to facilitate comprehensive evaluation. By applying dimensionality reduction, more manageable comparisons are attainable, and this is followed by the use of a domain-specific distance metric to assess similarity or disparity between a piece of generated content and a “ground truth,” which can be derived by obtaining insights from, e.g., a subject matter expert and curating a sentence vector from the insights for finetuning and evaluation. Moreover, the system can analyze additional biases to make the evaluation more accurate and reflective of specific domain conditions, culminating in the generation of an encompassing, integrated evaluation score.

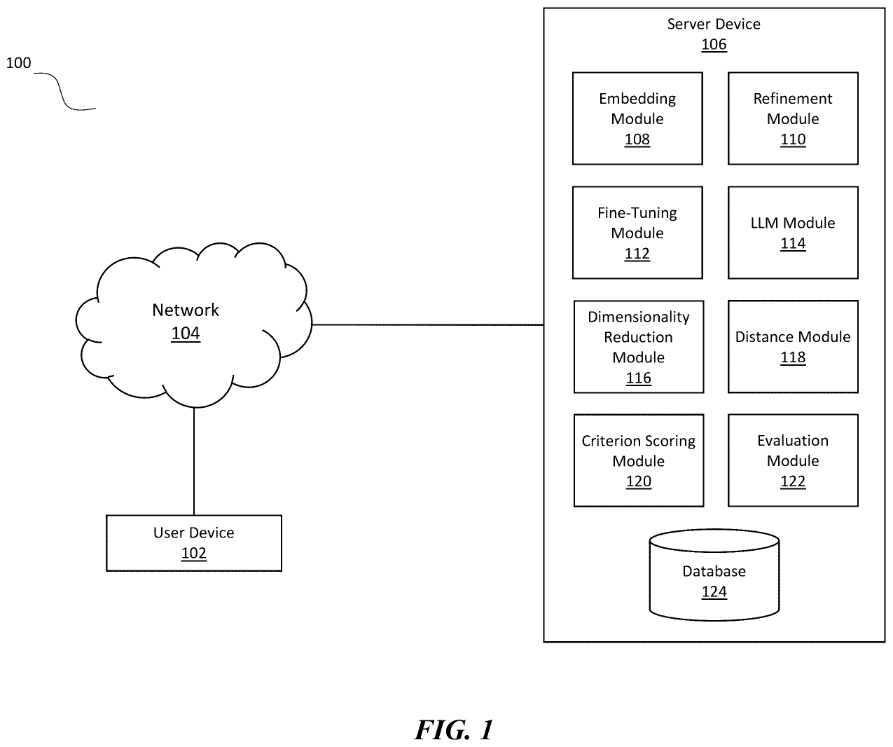

FIG. 1 is a block diagram of an example system 100 for enhanced content evaluation according to example embodiments of the present disclosure. The system 100 can include one or more user devices 102 (generally referred to herein as a “user device 102” or collectively referred to herein as “user devices 102”) that can access, via network 104, content generated by the server 106. For example, the server 106 can function as a content generation server that generates a variety of content. In addition, the server 106 can function as a tool for evaluating content that has been generated, whether the content has been generated by the server 106 or elsewhere. The server 106 and its various modules, described below, can execute various content evaluation processes.

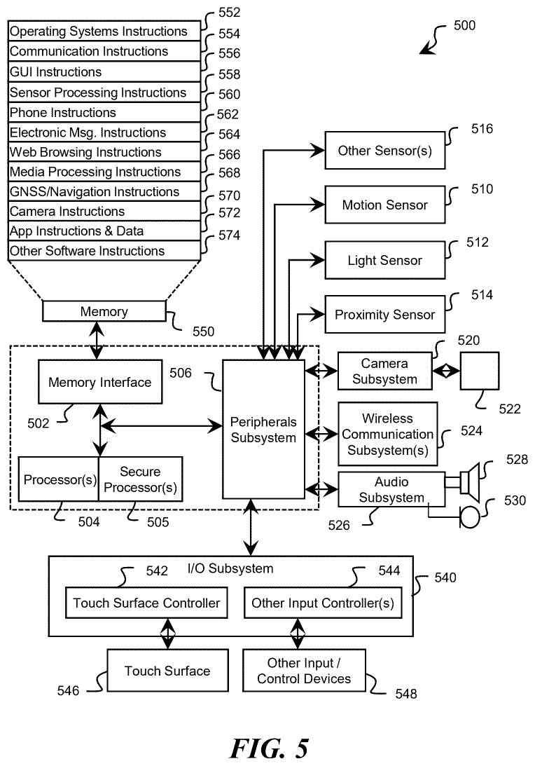

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, tablet, or other suitable device. In some embodiments, a user device 102 can be the same as or similar to the computing device 500 described below with respect to FIG. 5. In some embodiments, the system 100 can include any number of user devices 102.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

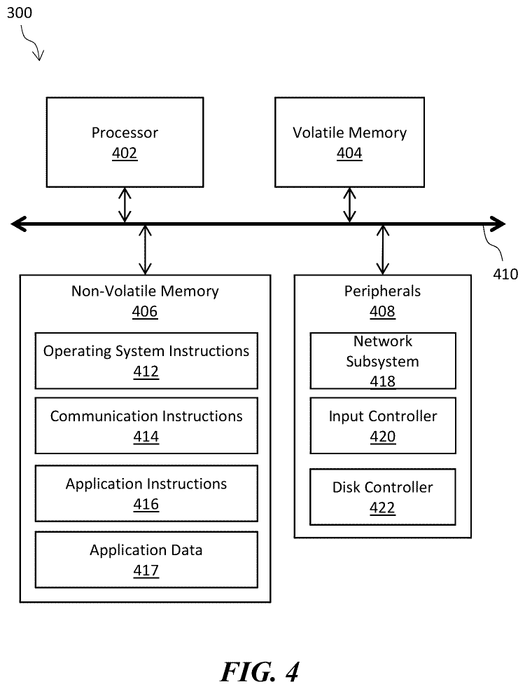

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 400 described below in the context of FIG. 4.

As shown in FIG. 1, the server 106 includes an embedding module 108, a refinement module 110, a fine-tuning module 112, an LLM module 114, a dimensionality reduction module 116, a distance module 118, a criterion scoring module 120, and an evaluation module 122. The server 106 can also include a database 124 that is configured to store and maintain various domains and their elements. For example, a domain can include SQL elements like tables, columns, and actions (e.g., SELECT, JOIN, etc.).

In some embodiments, the embedding module 108 is configured to create initial vector representations (i.e., an “initial embedding”) of domain-specific elements that make up the specific domain. In other words, the embedding module 108 is configured to apply various vectorization techniques to embed data, such as text, to vector form within a continuous vector space. In some embodiments, a word2vec model may be used to embed text to the vector space. The word2vec model may use a continuous bag-of-words approach (CBOW), a skip-gram approach, or other similar approaches. In some embodiments, embedding module 108 can employ other embedding frameworks such as GloVe (Global Vector) or FastText. In some embodiments, embedding module 108 may be tunable. The parameters used to create vector representations can be variable and can be adjusted or tuned based on learning (additional details are discussed in relation to the refinement module 110 and the fine-tuning module 112). In some embodiments, embedding module 108 may include an encoder and/or a neural network architecture to perform the embedding processes.

In some embodiments, the refinement module 110 is configured to refine embeddings generated by the embedding module 108. The refinement module 110 can be configured to perform refinements using a neural network, such as a GNN, although this not limiting. In some embodiments, the refinement module 110 can alternatively or additionally utilize a recurring neural network (RNN), a convolutional neural network (CNN), autoencoders, etc. In some embodiments, the refinement module 110 can employ such neural network architectures to enhance the initial embeddings by incorporating complex relational and structural knowledge from the domain. In some embodiments, the refinement module 110 can construct a GNN where nodes represent the embeddings of domain elements and edges connecting the nodes denote the relationships therebetween. In some embodiments, the GNN of the refinement module 110 can update the embeddings to reflect these relationships more accurately, which can enrich the initial representations with deeper domain-specific insights.

In some embodiments, the fine-tuning module 112 is configured to further refine the embeddings generated by the embedding module 108 by incorporating explicit domain knowledge via various fine-tuning techniques. In some embodiments, the fine-tuning module 112 is configured to use a fine-tuned LLM or other embedding model that has been specifically adapted to the domain. For example, the fine-tuned LLM or other model can adjust the refined embeddings based on domain-specific contexts and nuances, such as common patterns, mandatory JOINs in the case of SQL, etc. In some embodiments, this can involve training the LLM on a corpus of domain-enriched text to capture sophisticated patterns and rules inherent to that domain. In some embodiments, this LLM can be included within the LLM module 114, discussed below. In some embodiments, fine-tuning the embeddings can include manual fine-tuning. For example, domain experts can manually refine embeddings to encode known relationships, constraints, and/or patterns that may not be fully captured through automatic methods alone. In these examples, the fine-tuning module 112 can receive an input or other feedback from a user/domain expert via the user device 102 and fine-tune the embedding based on the received input.

In some embodiments, the LLM module 114 includes an LLM, such as e.g., GPT-3, -3.5, -4, PaLM, Ernie Bot, LLaMa, and others. In some embodiments, an LLM can include various transformed-based models trained on vast corpuses of data that utilize an underlying neural network. The LLM module 114 can generate various types of content, such as in response to a user query or in other types of applications.

In some embodiments, the embedding module 108 is configured to utilize the domain-specific embeddings (i.e., the refined and fine-tuned version of the original embeddings generated by the embedding module 108) to convert content generated by the LLM module 114 into a vector. In other words, the embedding module 108 vectorizes content generated by the LLM module 114 to form a content vector. In addition, the embedding module 108 can access a ground truth and vectorize the ground truth to generate a ground truth vector. In some embodiments, such vectorization techniques can help ensure that subsequent evaluation techniques can capture the full complexity and nuance of the domain-specific elements and relationships within the generated content.

In some embodiments, the dimensionality reduction module 116 employ various dimensionality reduction techniques to reduce the latent space of a vector, such as the content vector and the ground truth vector generated by the embedding module 108. In some embodiments, the dimensionality reduction module 116 can be configured to apply a t-distributed stochastic neighbor embedding (t-SNE) technique. t-SNE techniques can reduce the dimensionality of data while preserving the local structure of the original high-dimensional space. In some embodiments, the technique can be particularly effective for datasets where preserving the local relationships between points (e.g., the similarity between specific SQL queries) is desirable. t-SNE works by converting the high-dimensional Euclidean distances between points into conditional probabilities that represent similarities. The technique generally aims to minimize the divergence between these probabilities in both the high and low-dimensional spaces, which can ensure that similar items remain close to each other in the reduced space. In some embodiments, the dimensionality reduction module 116 can be configured to apply a uniform manifold approximation and projection (UMAP) technique. UMAP techniques preserve local structure and also better maintain the global data structure compared to other dimensionality reduction techniques. UMAP techniques can work by constructing a high-dimensional graph representing the original data and then attempting to optimize the layout of this graph in a lower-dimensional space. In some embodiments, UMAP can be faster than t-SNE and provide better clustering capabilities, making it suitable for complex domain-specific datasets where both local and global structures are important. In some embodiments, the dimensionality reduction module 116 can choose between t-SNE and UMAP techniques, and the choice can depend on the specific characteristics of the data and the requirements of the evaluation task. Both techniques can facilitate a more manageable comparison of vectors by reducing the complexity of the data space while retaining relationship information. In some embodiments, the dimensionality reduction module 116 is also configured to utilize other dimensionality reduction techniques in addition t-SNE and UMAP.

In some embodiments, the distance module 118 is configured to evaluate the similarity between vectors, such as the content vector and the ground truth vector generated by the embedding module 108. In some embodiments, the distance module 118 is configured to apply various different distance metrics, such as cosine similarity, Euclidean distance, Manhattan distance, and a weighted distance. In some embodiments, cosine similarity can measure the cosine of the angle between the two vectors. In some embodiments, cosine similarity can be useful when the magnitude of the vectors is not as relevant as the orientation (i.e., the direction or pattern of the data). Cosine similarity is often used in text analysis where the presence or absence of specific terms (and their relative frequencies) is more desirable than the absolute term counts. In some embodiments, the Euclidean distance can represent the “straight-line” distance between two points in multidimensional space. The Euclidean distance can measure the absolute difference between the two vectors and can be effective when the scale of the components and the magnitude of the vectors are desirable for the evaluation. In some embodiments, the Manhattan distance can calculate the sum of the absolute differences of the Cartesian coordinates of the vectors. Also known as the “taxicab” or “city block” distance, this metric can be used when it is desirable to emphasize differences in individual dimensions or features of the embeddings. In some embodiments, a weighted distance can be a variation of the above metrics where individual dimensions are weighted differently, reflecting their importance in the domain-specific context. This approach can enable the tailoring of distance calculation to emphasize more significant features while downplaying less desirable ones. In some embodiments, the distance module 118 can be configured to select particular distance metrics to employ based on the domain's characteristics and the specific nature of the content being evaluated.

In some embodiments, the criterion scoring module 120 is configured to score various domain-specific criteria of vectors (e.g., the content vector and the ground truth vector) such as, for example, accuracy, conciseness, domain relevance, and compliance with known standards or patterns. In some embodiments, accuracy can be quantified by measuring how closely the generated content matches the domain-specific facts or data points in the ground truth. This can involve a detailed analysis of the content's adherence to factual accuracy or the presence of errors. In some embodiments, an LLM (which may be included within the LLM module 114) can be used to discern this. In some embodiments, conciseness can evaluate the brevity and directness of the generated content, for example by using metrics that penalize redundancy or unnecessary complexity. This can involve calculating the ratio of informative content to the overall content length or assessing the efficiency of information presentation. In some embodiments, domain relevance can assess how relevant and applicable the content is within the specific domain context. This can involve domain-specific keyword analysis, relevance scoring models, or expert evaluations. In some embodiments, compliance can measure the extent to which the generated content adheres to established domain standards, patterns, or practices. This can involve checklists, pattern recognition algorithms, or compliance scoring models developed in consultation with domain experts.

In some embodiments, the evaluation module 122 is configured to calculate an evaluation score using, for example, the distance metric generated by the distance module 118 and the one or more criterion scores calculated by the criterion scoring module 120. In some embodiments, each of the scores and distances can be quantified and integrated into the overall evaluation score using, for example, a weighted sum approach, where weights can reflect the relative importance of each criterion in the domain-specific evaluation context. Such a structured and comprehensive approach can ensure that the final evaluation score not only reflects the content's similarity to the ground truth but also its quality and utility from multiple domain-specific perspectives. In other words, the evaluation module 122 can combine both quantitative and qualitative assessments into a single, comprehensive evaluation metric. In some embodiments, the evaluation score can be calculated according to Equation (1) below:

$$S = {w}_{1} * d ( \vec{{c}_{gt}^{′}} , \vec{{c}_{gen}^{′}} ) + {\sum }_{j = 2}^{N} {w}_{j} * {M}_{j} ( content ) \qquad ( 1 )$$

where S represents the evaluation score, d represents the domain specific distance metric, c represents the reduced content vector and reduced ground truth vector, M represents additional evaluation metrics (e.g., criterion scores), and w reflects the importance of each criterion.

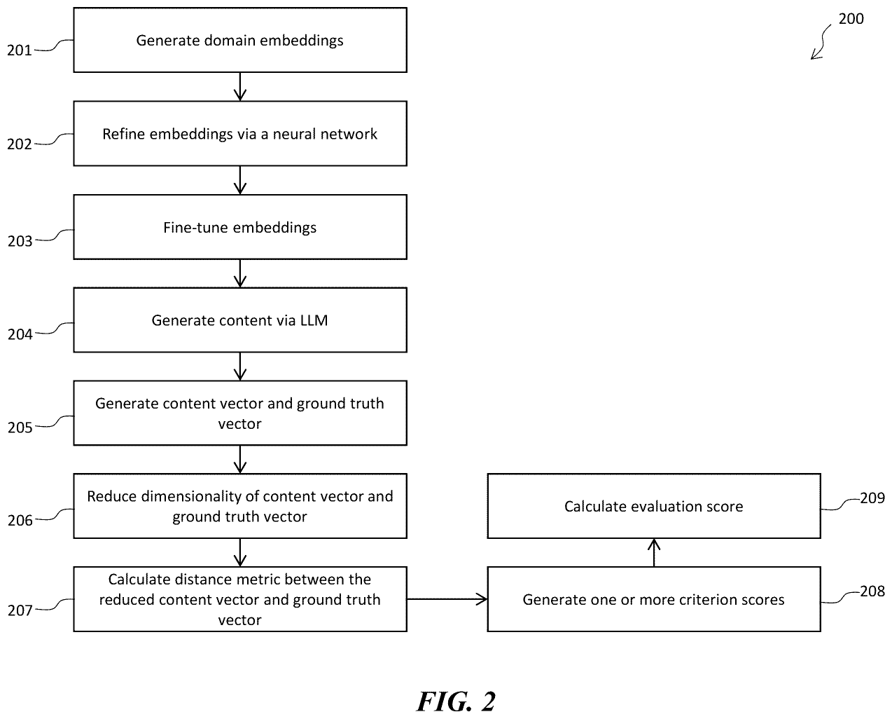

FIG. 2 is a flowchart of an example enhanced content evaluation process 200 according to example embodiments of the present disclosure. In some embodiments, the process 200 can be performed by the server 106 and its various modules. At block 201, the embedding module 108 generates domain embeddings of domain-specific elements that make up a certain domain. In some embodiments, the embedding module 108 can apply various vectorization techniques to embed data, such as text, to a vector form within a vector space. As discussed above, the embedding module 108 can utilize various vectorization techniques such as word2vec, GloVe, FastText, etc.

At block 202, the refinement module 110 refines the domain embeddings generated by the embedding module 108 via a neural network. In some embodiments, the neural network can include one or more of a GNN, an RNN, a CNN, various autoencoders, etc. In some embodiments, the refinement module 110 can employ such neural network architectures to enhance the initial embeddings by incorporating complex relational and structural knowledge from the domain. In some embodiments, the refinement module 110 can utilize a GNN to refine the embeddings where nodes represent the embeddings of domain elements and edges connecting the nodes denote the relationships therebetween. At block 203, the fine-tuning module 112 further refines the embeddings by fine-tuning the refined embeddings. In some embodiments, fine-tuning the embeddings can incorporate explicit domain knowledge into the embeddings. In some embodiments, the fine-tuning module 112 can fine-tune the embedding using a fine-tuned LLM or other embedding model that has been specifically adapted to the relevant domain. For example, the fine-tuned LLM or other model can adjust the refined embeddings based on domain-specific contexts and nuances, such as common patterns, mandatory JOINs in the case of SQL, etc. In some embodiments, fine-tuning the embeddings can alternatively or additionally include manual fine-tuning. For example, domain experts can manually refine embeddings to encode known relationships, constraints, and/or patterns; the fine-tuning module 112 can receive an input or other feedback from a user/domain expert via the user device 102 and fine-tune the embedding in a corresponding manner based on the received input. At block 204, the LLM module 114 generates content, such as in response to a user query or in other types of applications.

At block 205, the embedding module 108 generates a content vector and a ground truth vector. In particular, the embedding module 108 can utilize domain-specific embeddings (i.e., the refined and fine-tuned version of the original embeddings generated by the embedding module 108). In the case of the content vector, the embedding module 108 converts content generated by the LLM module 114 into a vector. In the case of the ground truth vector, the embedding module 108 converts a ground truth into a ground truth vector. As discussed above in relation to FIG. 1, such vectorization techniques can help ensure that subsequent evaluation techniques can capture the full complexity and nuance of the domain-specific elements and relationships within the generated content.

At block 206, the dimensionality reduction module 116 reduces the dimensionality of the content vector and the ground truth vector. In some embodiments, reducing the dimensionality of the vectors can be performed using a t-SNE technique, a UMAP technique, or other technique that reduces the latent space of the vectors. At block 207, the distance module 118 calculates a distance metric between the reduced content vector and reduced ground truth vector. As discussed above in relation to FIG. 1, the distance module 118 can use one or more of various types of distance metrics, such as cosine similarity, Euclidean distance, Manhattan distance, or a weighted distance. In some embodiments, calculating the distance metric between the reduced content vector and reduced ground truth vector can include, selecting a particular distance metric based on the domain's characteristics and the specific nature of the content being evaluated.

At block 208, the criterion scoring module 120 generates one or more criterion scores for the vectors using one or more domain-specific criteria. For example, the criterion scoring module 120 can score various criteria such as accuracy, conciseness, domain relevance, and compliance with known standards or patterns. At block 209, the evaluation module 122 calculates an evaluation score using the distance metric generated by the distance module 118 and the one or more criterion scores calculated by the criterion scoring module 120. In some embodiments, calculating the evaluation score can include using a weighted sum approach, where weights can reflect the relative importance of each criterion in the domain-specific evaluation context. The evaluation score can be calculated using, in some embodiments, Equation (1) described above. The resulting evaluation score can be used by various experts and users to evaluate the quality and relevance of the content generated by the LLM module 114, and make alterations to the LLM module 114 in response thereto.

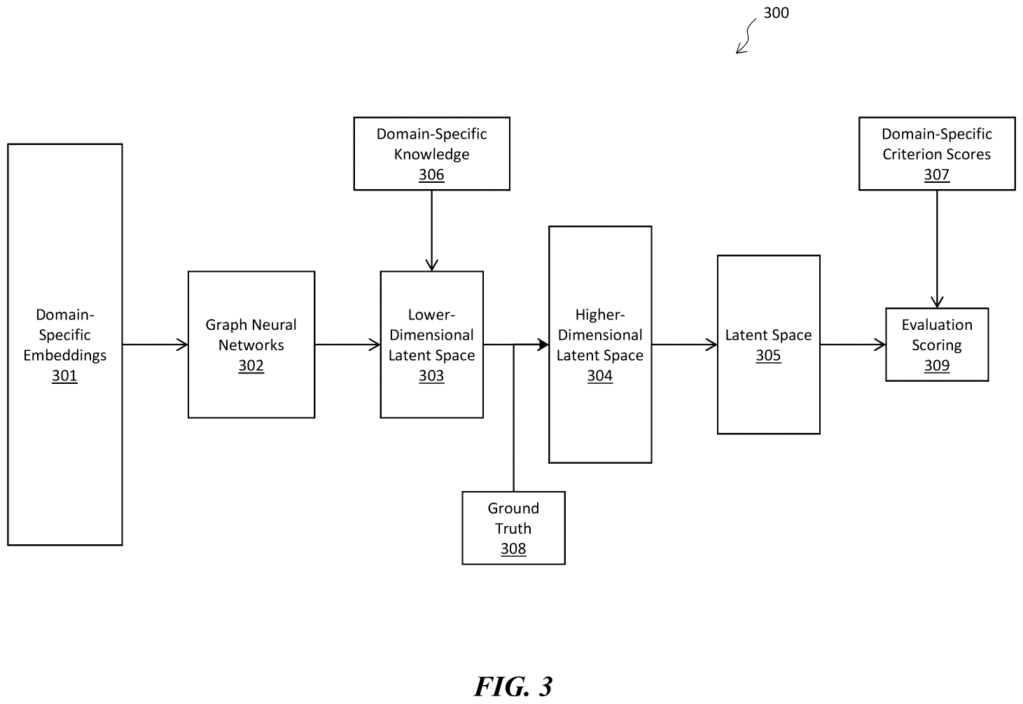

FIG. 3 is an example architecture 300 for enhanced content evaluation according to some embodiments of the present disclosure. The architecture 300 can include various domain-specific embeddings 301, which can have been created by the embedding module 108. The domain-specific embeddings can be fed to one or more GNNs 302, which are maintained by the refinement module 110. Here, the refinement module 110 can refine the embeddings using the GNN(s). Then, the refined embeddings can be fed to a lower-dimensional latent space 303 and fine-tuned, via the fine-tuning module 112, with various domain-specific knowledge 306. The resulting embeddings (i.e., the refined and fine-tuned embeddings) can be utilized by the embedding module 108 to vectorize a piece of content generated by the LLM module 114 and a related ground truth 308. At 304, each of these vectors (i.e., the ground truth vector and the content vector) can have their dimensionality reduced via the dimensionality reduction module 116. The reduced vectors are fed to the distance module 118 at 305, where a distance metric is calculated in the reduced latent space. At 307, the criterion scoring module 120 can calculate various domain-specific criterion scores. Finally, at 309, the evaluation module 122 can combine the distance metric and the various domain-specific criterion scores to generate the evaluation score.

FIG. 4 is a diagram of an example server device 400 that can be used within system 100 of FIG. 1. Server device 400 can implement various features and processes as described herein. Server device 400 can be implemented on any electronic device that runs software applications derived from complied instructions, including without limitation personal computers, servers, smart phones, media players, electronic tablets, game consoles, email devices, etc. In some implementations, server device 400 can include one or more processors 402, volatile memory 404, non-volatile memory 406, and one or more peripherals 408. These components can be interconnected by one or more computer buses 410.

Processor(s) 402 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 410 can be any known internal or external bus technology, including but not limited to ISA, EISA, PCI, PCI Express, USB, Serial ATA, or FireWire. Volatile memory 404 can include, for example, SDRAM. Processor 402 can receive instructions and data from a read-only memory or a random access memory or both. Essential elements of a computer can include a processor for executing instructions and one or more memories for storing instructions and data.

Non-volatile memory 406 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 406 can store various computer instructions including operating system instructions 412, communication instructions 414, application instructions 416, and application data 417. Operating system instructions 412 can include instructions for implementing an operating system (e.g., Mac OS®, Windows®, or Linux). The operating system can be multi-user, multiprocessing, multitasking, multithreading, real-time, and the like. Communication instructions 414 can include network communications instructions, for example, software for implementing communication protocols, such as TCP/IP, HTTP, Ethernet, telephony, etc. Application instructions 416 can include instructions for various applications. Application data 417 can include data corresponding to the applications.

Peripherals 408 can be included within server device 400 or operatively coupled to communicate with server device 400. Peripherals 408 can include, for example, network subsystem 418, input controller 420, and disk controller 422. Network subsystem 418 can include, for example, an Ethernet of WiFi adapter. Input controller 420 can be any known input device technology, including but not limited to a keyboard (including a virtual keyboard), mouse, track ball, and touch-sensitive pad or display. Disk controller 422 can include one or more mass storage devices for storing data files; such devices include magnetic disks, such as internal hard disks and removable disks; magneto-optical disks; and optical disks.

FIG. 5 is an example computing device that can be used within the system 100 of FIG. 1, according to an embodiment of the present disclosure. In some embodiments, device 500 can be user device 102. The illustrative user device 500 can include a memory interface 502, one or more data processors, image processors, central processing units 504, and or secure processing units 505, and peripherals subsystem 506. Memory interface 502, one or more central processing units 504 and or secure processing units 505, and or peripherals subsystem 506 can be separate components or can be integrated in one or more integrated circuits. The various components in user device 500 can be coupled by one or more communication buses or signal lines.

Sensors, devices, and subsystems can be coupled to peripherals subsystem 506 to facilitate multiple functionalities. For example, motion sensor 510, light sensor 512, and proximity sensor 514 can be coupled to peripherals subsystem 506 to facilitate orientation, lighting, and proximity functions. Other sensors 516 can also be connected to peripherals subsystem 506, such as a global navigation satellite system (GNSS) (e.g., GPS receiver), a temperature sensor, a biometric sensor, magnetometer, or other sensing device, to facilitate related functionalities.

Camera subsystem 520 and optical sensor 522, e.g., a charged coupled device (CCD) or a complementary metal-oxide semiconductor (CMOS) optical sensor, can be utilized to facilitate camera functions, such as recording photographs and video clips. Camera subsystem 520 and optical sensor 522 can be used to collect images of a user to be used during authentication of a user, e.g., by performing facial recognition analysis.

Communication functions can be facilitated through one or more wired and or wireless communication subsystems 524, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 524. The specific design and implementation of communication subsystems 524 can depend on the communication network(s) over which the user device 500 is intended to operate. For example, user device 500 can include communication subsystems 524 designed to operate over a GSM network, a GPRS network, an EDGE network, a WiFi or WiMax network, and a Bluetooth™ network. For example, wireless communication subsystems 524 can include hosting protocols such that device 500 can be configured as a base station for other wireless devices and or to provide a WiFi service.

Audio subsystem 526 can be coupled to speaker 528 and microphone 530 to facilitate voice-enabled functions, such as speaker recognition, voice replication, digital recording, and telephony functions. Audio subsystem 526 can be configured to facilitate processing voice commands, voice-printing, and voice authentication, for example.

I/O subsystem 540 can include a touch-surface controller 542 and or other input controller(s) 544. Touch-surface controller 542 can be coupled to a touch-surface 546. Touch-surface 546 and touch-surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 546.

The other input controller(s) 544 can be coupled to other input/control devices 548, such as one or more buttons, rocker switches, thumb-wheel, infrared port, USB port, and or a pointer device such as a stylus. The one or more buttons (not shown) can include an up/down button for volume control of speaker 528 and or microphone 530.

In some implementations, a pressing of the button for a first duration can disengage a lock of touch-surface 546; and a pressing of the button for a second duration that is longer than the first duration can turn power to user device 500 on or off. Pressing the button for a third duration can activate a voice control, or voice command, module that enables the user to speak commands into microphone 530 to cause the device to execute the spoken command. The user can customize a functionality of one or more of the buttons. Touch-surface 546 can, for example, also be used to implement virtual or soft buttons and or a keyboard.

In some implementations, user device 500 can present recorded audio and or video files, such as MP3, AAC, and MPEG files. In some implementations, user device 500 can include the functionality of an MP3 player, such as an iPod™. User device 500 can, therefore, include a 36-pin connector and or 8-pin connector that is compatible with the iPod. Other input/output and control devices can also be used.

Memory interface 502 can be coupled to memory 550. Memory 550 can include high-speed random access memory and or non-volatile memory, such as one or more magnetic disk storage devices, one or more optical storage devices, and or flash memory (e.g., NAND, NOR). Memory 550 can store an operating system 552, such as Darwin, RTXC, LINUX, UNIX, OS X, Windows, or an embedded operating system such as VxWorks.

Operating system 552 can include instructions for handling basic system services and for performing hardware dependent tasks. In some implementations, operating system 552 can be a kernel (e.g., UNIX kernel). In some implementations, operating system 552 can include instructions for performing voice authentication.

Memory 550 can also store communication instructions 554 to facilitate communicating with one or more additional devices, one or more computers and or one or more servers. Memory 550 can include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic messaging-related process and functions; web browsing instructions 564 to facilitate web browsing-related processes and functions; media processing instructions 566 to facilitate media processing-related functions and processes; GNSS/Navigation instructions 568 to facilitate GNSS and navigation-related processes and instructions; and or camera instructions 570 to facilitate camera-related processes and functions.

Memory 550 can store application (or “app”) instructions and data 572, such as instructions for the apps described above in the context of FIGS. 1-3. Memory 550 can also store other software instructions 574 for various other software applications in place on device 500. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions operable to cause the processor to perform operations comprising:
generating content via a large language model (LLM);
generating a content vector by vectorizing the generated content via a domain-specific embedding associated with a domain;
generating a ground truth vector by vectorizing a ground truth;
reducing a dimensionality of each of the content vector and the ground truth vector to generate a reduced content vector and a reduced ground truth vector;
calculating a distance metric between the reduced content vector and the reduced ground truth vector;
generating one or more criterion scores for the reduced content vector; and
calculating an evaluation score based on the distance metric and the one or more criterion scores.

2. The computing system of claim 1, wherein the domain-specific embedding is generated by:
generating an initial embedding by vectorizing a plurality of elements within the domain to create a plurality of domain-specific vectors, the initial embedding comprising the plurality of domain-specific vectors;
refining the initial embedding via a neural network; and
fine-tuning the refined initial embedding via the LLM to generate the domain-specific embedding.

3. The computing system of claim 2, wherein refining the initial embedding via the neural network comprises refining the initial embedding via a graph neural network (GNN).

4. The computing system of claim 3, wherein the GNN comprises:
a plurality of nodes representing the plurality of domain-specific vectors; and
a plurality of edges connecting the plurality of nodes.

5. The computing system of claim 2, wherein the operations further comprise:
receiving, from a user device, an input associated with the initial embedding; and
refining the initial embedding based on the input.

6. The computing system of claim 1, wherein reducing the dimensionality of each of the content vector and the ground truth vector comprises at least one of t-distributed stochastic neighbor embedding (t-SNE) or uniform manifold approximation and projection (UMAP).

7. The computing system of claim 1, wherein calculating the distance metric between the reduced content vector and the reduced ground truth vector comprises calculating at least one of a cosine similarity, a Euclidean distance, a Manhattan distance, or a weighted distance between the reduced content vector and the reduced ground truth vector.

8. The computing system of claim 1, wherein generating the one or more criterion scores for the reduced content vector comprises at least one of:
generating an accuracy value between one or more data points in the reduced content vector and the reduced ground truth vector;
generating a conciseness value associated with the reduced content vector;
generating a relevance value for the reduced content vector representing a relevance to one or more domain-specific keywords; or
generating a compliance value for the reduced content vector representing compliance with a predefined standard.

9. The computing system of claim 8, wherein generating the accuracy value between the one or more data points in the reduced content vector and the reduced ground truth vector comprises quantifying a factual accuracy via a second LLM.

10. The computing system of claim 1, wherein calculating the evaluation score based on the distance metric and the one or more criterion scores comprises calculating a weighted sum of the distance metric and the one or more criterion scores.

11. A computer-implemented method, performed by at least one processor, comprising:
generating content via a large language model (LLM);
generating a content vector by vectorizing the generated content via a domain-specific embedding associated with a domain;
generating a ground truth vector by vectorizing a ground truth;
reducing a dimensionality of each of the content vector and the ground truth vector to generate a reduced content vector and a reduced ground truth vector;
calculating a distance metric between the reduced content vector and the reduced ground truth vector;
generating one or more criterion scores for the reduced content vector; and
calculating an evaluation score based on the distance metric and the one or more criterion scores.

12. The computer-implemented method of claim 11, wherein the domain-specific embedding is generated by:
generating an initial embedding by vectorizing a plurality of elements within the domain to create a plurality of domain-specific vectors, the initial embedding comprising the plurality of domain-specific vectors;
refining the initial embedding via a neural network; and
fine-tuning the refined initial embedding via the LLM to generate the domain-specific embedding.

13. The computer-implemented method of claim 12, wherein refining the initial embedding via a neural network comprises refining the initial embedding via a graph neural network (GNN).

14. The computer-implemented method of claim 13, wherein the GNN comprises:
a plurality of nodes representing the plurality of domain-specific vectors; and
a plurality of edges connecting the plurality of nodes.

15. The computer-implemented method of claim 12 comprising:
receiving, from a user device, an input associated with the initial embedding; and
refining the initial embedding based on the input.

16. The computer-implemented method of claim 11, wherein reducing the dimensionality of each of the content vector and the ground truth vector comprises at least one of t-distributed stochastic neighbor embedding (t-SNE) or uniform manifold approximation and projection (UMAP).

17. The computer-implemented method of claim 11, wherein calculating the distance metric between the reduced content vector and the reduced ground truth vector comprises calculating at least one of a cosine similarity, a Euclidean distance, a Manhattan distance, or a weighted distance between the reduced content vector and the reduced ground truth vector.

18. The computer-implemented method of claim 11, wherein generating the one or more criterion scores for the reduced content vector comprises at least one of:
generating an accuracy value between one or more data points in the reduced content vector and the reduced ground truth vector;
generating a conciseness value associated with the reduced content vector;
generating a relevance value for the reduced content vector representing a relevance to one or more domain-specific keywords; or
generating a compliance value for the reduced content vector representing compliance with a predefined standard.

19. The computer-implemented method of claim 18, wherein generating the accuracy value between the one or more data points in the reduced content vector and the reduced ground truth vector comprises quantifying a factual accuracy via a second LLM.

20. The computer-implemented method of claim 11, wherein calculating the evaluation score based on the distance metric and the one or more criterion scores comprises calculating a weighted sum of the distance metric and the one or more criterion scores.
